(19) United States
(12) Patent Application Publication
(10) Pub. No.: US 2013/0244655 A1
(43) Pub. Date: Sep. 19, 2013

(54) METHODS AND DEVICES FOR FACILITATING FAST CELL RESELECTION AT CALL RELEASE

(71) Applicants: Francesco Pica, San Diego, CA (US); Ralf Weber, Kalchreuth (DE)

(72) Inventors: Francesco Pica, San Diego, CA (US); Ralf Weber, Kalchreuth (DE)

(73) Assignee: Qualcomm Incorporated, San Diego, CA (US)

(21) Appl. No.: 13/615,027

(22) Filed: Sep. 13, 2012

Related U.S. Application Data
(60) Provisional application No. 61/605,065, filed on Feb. 29, 2012.

(51) Int. Cl. H04W 36/24

(52) U.S. Cl. CPC H04W 36/24
USPC 455/436

(57) ABSTRACT

Access terminals are adapted to receive cell selection instructions directing the access terminal to connect to a target cell from a serving cell upon a channel release. The access terminal may determine whether one or more signal parameters of the target cell are above respective threshold values. If the one or more signal parameters are above the respective threshold values, the access terminal connects to the target cell. If one or more signal parameters are not above the respective threshold values, the access terminal continues with the serving cell. Wireless network devices send a channel release message at the end of an active call. The channel release message can include a cell selection instruction directing the access terminal to connect to a target cell upon channel release. Other aspects, embodiments, and features are also claimed and described.

### CROSS REFERENCE TO RELATED APPLICATION & PRIORITY CLAIM

The present Application for Patent claims priority to Provisional Application No. 61/605,065 entitled “OPTIMIZED FAST CELL RESELECTION AT CALL RELEASE” filed Feb. 29, 2012, and assigned to the assignee hereof and hereby expressly incorporated by reference herein as if fully set forth below and for all applicable purposes.

### TECHNICAL FIELD

Embodiments relate generally to wireless communications, and more specifically, to methods and devices for facilitating optimized cell reselection on call release.

### BACKGROUND

In conventional wireless communication systems, a mobile device might participate in an active call. For example, as a wireless circuit switched call with a GSM network. When the active call is completed and the mobile device enters an idle mode from a connected mode, the network can send a release message, such as a channel release message or an RRC connection release message. In some instances, the release message may also include a cell selection indicator instructing the mobile device to camp on a cell that is different from the currently serving cell.

For example, the GSM specifications from Release 6 onward describe that, when a circuit switched call is completed with the GSM network, the network can send a channel release message to the mobile device. When the channel release message includes a cell selection indicator, the mobile device is instructed to camp on a UTRAN or E-UTRAN cell identified by the channel release message as quickly as possible. In other instances, the channel release message indicates a UTRAN or E-UTRAN frequency, and the mobile device is instructed to camp on a suitable cell in this frequency as soon as possible. If the mobile device cannot find a suitable cell within 10 seconds, or if none of the cells for an indicated frequency are suitable, the mobile device is allowed to camp on any suitable cell.

In some instances, the mobile device might change immediately from the GSM cell and connect to a WCDMA or LTE cell, as instructed by the channel release message with a cell selection indicator, only to determine that the signal-to-noise ratio and/or the signal power is below a threshold, which results in the mobile device returning to the GSM cell. For example, the following scenario can occur under the current rules. At the end of a circuit switched call in GSM, the mobile device moves back to WCDMA, regardless of the RF quality in WCDMA. The mobile device can select a WCDMA cell, but the WCDMA quality is poor (e.g., signal-to-noise is poor and/or signal strength is poor). The mobile device then reselects back to GSM due to the WCDMA reselection rules indicating that reselection should be performed if the signal-to-noise and/or signal strength are below some threshold. In some instances, the mobile device may move to WCDMA, but is then unable to find a suitable cell and remains in WCDMA in search of a suitable cell for the entire 10 seconds, before reverting back to the GSM cell.

### SUMMARY

Embodiments of the present invention are aimed at addressing the above and other issues. For example, some embodiments are configured to enable a mobile device to make a determination after ending the GSM call and before blindly connecting to a WCDMA/LTE cell. This enable mobile devices to optimize cell reselection on call release by improving cell reselection time.

Various examples and implementations of the present disclosure facilitate improvements to the cell selection features of one or more communications standards by enabling the access terminal to consider minimum thresholds for the target cell before moving from a serving cell and connecting to the target cell. According to at least one aspect of the present disclosure, access terminals are provided. One or more examples of such access terminals may include a communications interface adapted to facilitate wireless communications and a storage medium. The communications interface and the storage medium can be coupled to a processing circuit. The processing circuit may be adapted to receive a cell selection instruction directing the access terminal to connect to a target cell from a serving cell upon a channel release. The processing circuit may also be adapted to determine whether one or more signal parameters of the target cell are above respective threshold values. The processing circuit may be further adapted to connect to the target cell in response to the cell selection instruction and to the one or more signal parameters being above the respective threshold values.

One or more additional aspects of the present disclosure provide methods operational on an access terminal and/or access terminals including means to perform such methods. One or more examples of such methods may include receiving a cell selection instruction directing the access terminal to connect to a target cell from a serving cell upon a channel release. A determination may be made whether one or more signal parameters of the target cell are above respective threshold values. In response to the cell selection instruction and to the one or more signal parameters being above the respective threshold values, the access terminal may connect to the target cell.

Still further aspects of the present disclosure include machine-readable mediums comprising instructions operational on an access terminal. According to one or more examples, such instructions may cause a processor to receive a cell selection instruction directing the access terminal to connect to a target cell from a serving cell upon a channel release. The instructions may further cause the processor to determine whether one or more signal parameters of the target cell are above respective threshold values. The instructions may also cause the processor to connect to the target cell in response to both the cell selection instruction and to the one or more signal parameters being above the respective threshold values.

Additional aspects of the present disclosure provide wireless network devices. According to one or more examples, such wireless network devices may include a communications interface and a storage medium coupled to a processing circuit. The processing circuit may be adapted to send a channel release message to an access terminal The channel release message can include a cell selection instruction directing the access terminal to connect to a target cell upon channel release, and at least one threshold value indicating a respective value for at least one signal parameter that is to be met before connecting to the target cell.

Further aspects of the present disclosure include methods operational on a wireless network device and/or wireless network devices including means for performing such methods. According to at least one example, such methods may include conducting an active call with an access terminal A channel release message may be sent to the access terminal, where the channel release message includes a cell selection instruction and one or more threshold values. The cell selection instruction may direct the access terminal to connect to a target cell upon channel release. The one or more threshold values may be adapted to indicate respective values for at least one signal parameters that is to be met before connecting to a target cell.

At least one additional aspect of the present disclosure includes processor-readable mediums comprising instructions operational on a wireless network device. According to one or more examples, such instructions may cause a processor to conduct an active call with an access terminal, and send a channel release message to the access terminal. The channel release message may include a cell selection instruction directing the access terminal to connect to a target cell upon channel release. The channel release message may also include one or more threshold values indicating respective values for one or more signal parameters that are to be met before connecting to the target cell.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating select components of a wireless communication system according to at least one example.

FIG. 2 is a block diagram illustrating an example of an access terminal operating within an area where there are two coverage areas A and B representing different radio access technologies.

FIG. 3 is a simplified flow diagram illustrating a cell selection procedure according to at least one example.

FIG. 4 is a block diagram illustrating select components of an access terminal according to at least one example.

FIG. 5 is a flow diagram illustrating at least one example of a method operational on an access terminal according to some embodiments of the present invention.

FIG. 6 is a block diagram illustrating select components of a wireless network device according to at least one example.

FIG. 7 is a flow diagram illustrating at least one example of a method operational on a wireless network device according to some embodiments of the present invention.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form in order to avoid obscuring the described concepts and features.

The various concepts presented throughout this disclosure may be implemented across a broad variety of telecommunication systems, network architectures, and communication standards. For example, the concepts described herein may be employed is wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. A UTRA network (UTRAN) includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, FlashOFDM®, etc. UTRA, E-UTRA, and GSM are part of Universal Mobile Telecommunication System (UMTS). Long Term Evolution (LTE) is an improved release of UMTS that uses E-UTRA. UTRA, E-UTRA, GSM, UMTS and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. By way of example and not by way of limitation, certain aspects of the disclosure are described below for GSM, WCDMA and LTE, and related terminology may be found in much of the description below.

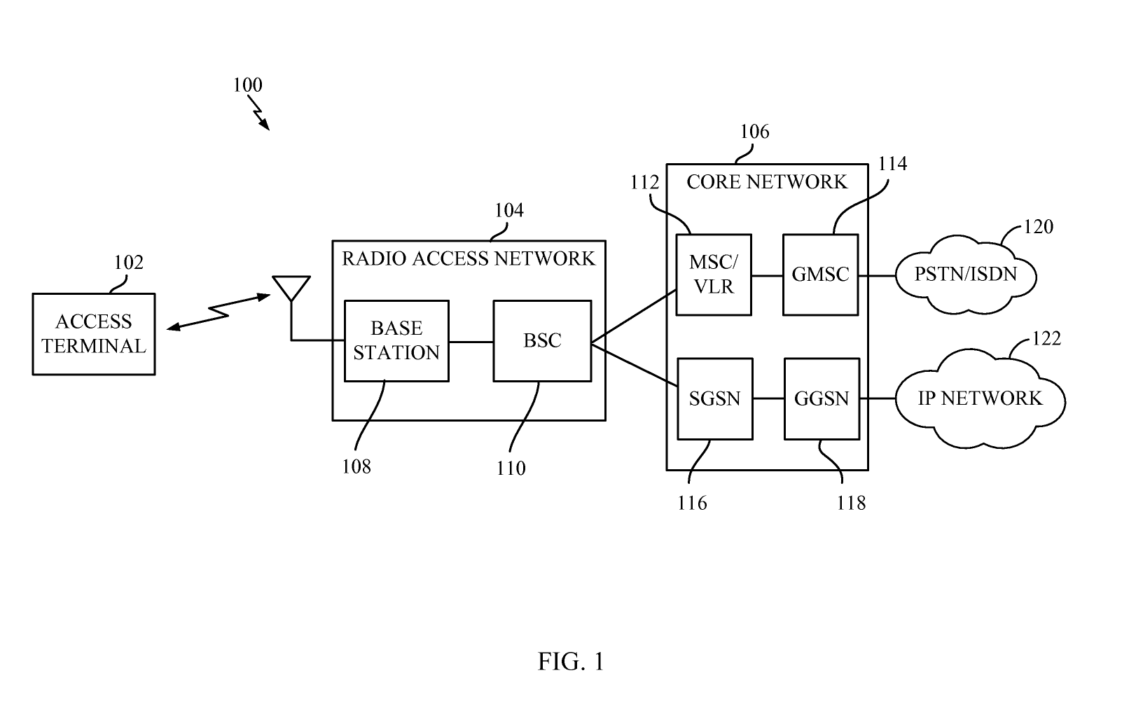

FIG. 1 is a block diagram illustrating select components of a wireless communication system 100 according to at least one example. In general, the wireless communication system 100 can include an access terminal 102, a radio access network 104, and a core network 106 that are adapted to interact with each other.

An access terminal 102 generally includes a device that communicates with one or more other devices through wireless signals. An access terminal may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Some non-limiting examples of access terminals include mobile phones, pagers, wireless modems, personal digital assistants, personal information managers (PIMs), personal media players, palmtop computers, laptop computers, tablet computers, televisions, appliances, e-readers, digital video recorders (DVRs), personal entertainment devices, network access points, and/or other communication/computing devices which communicate, at least partially, through a wireless or cellular network. One or more access terminals 102 can communicate with a wireless network through the radio access network 104.

The radio access network (RAN) 104 is generally adapted to manage traffic and signaling between one or more access terminals 102 and the core network 106. The radio access network 104 may also be referred to by those skill in the art as a base station subsystem (BSS), an access network, a UMTS Terrestrial Radio Access Network (UTRAN), etc. The radio access network 104 can include the one or more base stations 108 and a base station controller (BSC) 110.

The one or more base stations 108 are the interface element that facilitates wireless connectivity for one or more access terminals 102 to the network. The base station(s) 108 may also be referred to by those skilled in the art as an access point, a base transceiver stations (BTS), a radio base station, a radio transceiver, a transceiver function, a basic service set (BSS), an extended service set (ESS), a Node B, a femto cell, a pico cell, or some other suitable terminology.

The one or more base stations 108 are communicatively coupled with the base station controller (BSC) 110, which may also be referred to by those of skill in the art as a radio network controller (RNC). The base station controller 110 is generally responsible for the establishment, release, and maintenance of wireless connections within one or more coverage areas associated with the one or more base stations 108 which are connected to the base station controller 110. The base station controller 110 can be communicatively coupled to one or more nodes of the core network 106.

The core network 106 is a portion of the wireless communications system 100 that provides various services to access terminals 102 that are connected via the radio access network 104. The core network 106 may include a circuit-switched (CS) domain and a packet-switched (PS) domain. Some examples of circuit-switched elements include a mobile switching center (MSC) and visitor location register (VLR), identified as MSC/VLR 112, as well as a Gateway MSC (GMSC) 114. Some examples of packet-switched elements include a Serving GPRS Support Node (SGSN) 116 and a Gateway GPRS Support Node (GGSN) 118. Other network elements may be includes, such as a EIR, HLR, VLR and AuC, some or all of which may be shared by both the circuit-switched and packet-switched domains. An access terminal 102 can obtain access to a public switched telephone network (PSTN) 120 via the circuit-switched domain, and to an IP network 122 via the packet-switched domain.

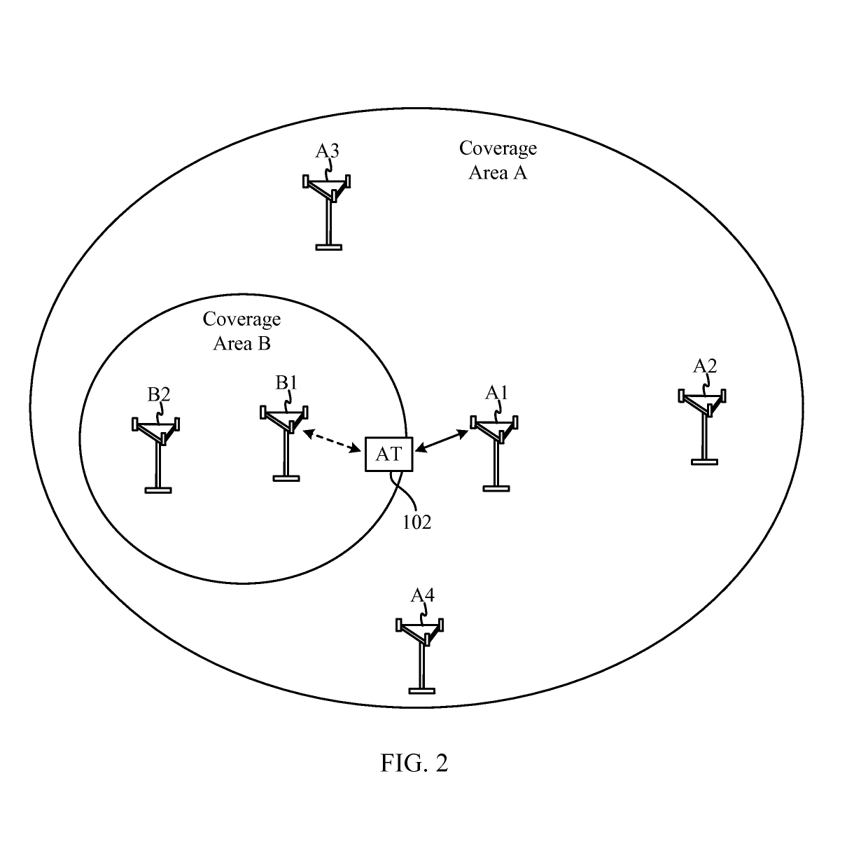

FIG. 2 illustrates an example of an access terminal 102 within a first coverage area A served by base stations 108 identified as A1, A2, A3, and A4, and within a second coverage area B served by base stations 108 identified as B1 and B2. As shown in FIG. 2, the access terminal 102 is actively communicating with the base station A1 in the first coverage area A. The cell associated with the base station A1 may accordingly be referred to as the serving cell. Coverage area A employs radio access technology A while coverage area B employs radio access technology B. For example, the coverage area A may employ GSM, while the coverage area B may employ WCDMA or LTE, although a person of ordinary skill in the art will recognized that other and/or different radio access technologies may be employed.

In the example illustrated in FIG. 2, the access terminal 102 is shown conducting a circuit-switched call with the base station A1 of the first coverage area A employing GSM, as depicted by the solid-line arrows between the access terminal 102 and the base station A1. When the circuit-switched call is finished, the base station A1 sends a channel release message to release all traffic channels (TCH) and standalone dedicated control channels (SDCCH). The channel release message can also include a cell reselection instruction. For example, the GSM specifications, from Release 6 onward, include the ability for the network to include a cell selection indicator after release of all traffic channels (TCH) and standalone dedicated control channels (SDCCH). These channels can be used by the access terminal 102 after release of the identified channels. This feature is further described in 3GPP standards documents TS 44.018 and TS 45.008, and in the 3GPP change request documents GP-040533 and GP040542, all of which documents are incorporated in their entirety herein by reference as is fully set forth in this document. In the example depicted in FIG. 2, the cell reselection instruction includes an indication that the access terminal 102 is to reselect to the cell associated with the base station B1 in coverage area B, as depicted by the broken-line arrow between the access terminal 102 and the base station B1. In other words, according to the cell reselection instruction received by the access terminal 102 at the end of the circuit-switched call with the GSM cell associated with base station A1 in coverage area A, the access terminal 102 is instructed to change as soon as possible from the GSM cell and camp on the UTRA/E-UTRA cell associated with the base station B1 in the coverage area B. The cell associated with the base station B1 can accordingly be referred to as the target cell.

According to a feature of the present disclosure, instead of connecting to the UTRA/E-UTRA of coverage area B as soon as possible, as conventionally defined by the 3GPP standards, the access terminal 102 is adapted to make a determination whether the signal-to-noise (e.g., EcNo) and the signal strength (e.g., received signal code power (RSCP)) are above some threshold values.

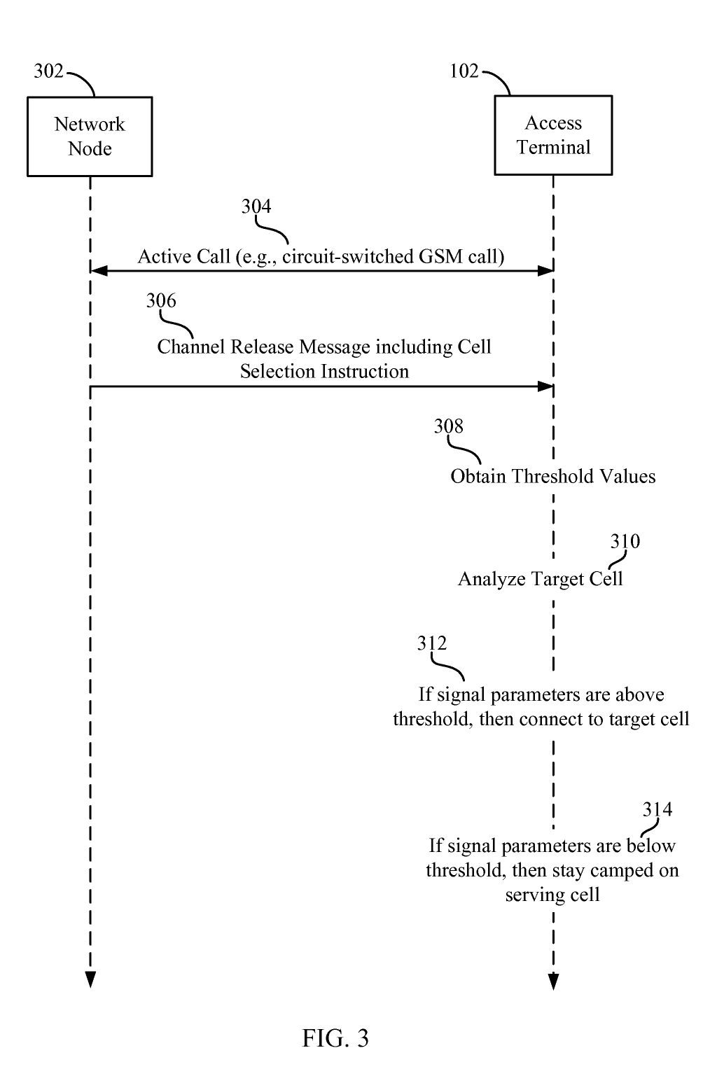

FIG. 3 is a simplified flow diagram illustrating cell selection procedure according to at least one example of the present disclosure. A wireless network device is identified in this example as a network node 302 for illustration purposes. The network node 302 is associated with a serving cell and may be implemented as a radio access network and/or a base station in a radio access network. Initially, the network node 302 and an access terminal 102 can participate in an active call at step 304. For example, the access terminal 102 may be participating in a circuit-switched GSM call with the network node 302. At the end of the active call, the network node 302 sends a channel release message 306. This channel release message includes a cell selection instruction, such as a cell selection indicator after release of all traffic channels (TCH) and standalone dedicated control channels (SDCCH). As noted above, this cell selection instruction tells the access terminal 102 to change from the serving cell and connect to a target cell. The cell selection instruction may specify the target cell by a particular base station or by a particular radio access technology (e.g., to WCDMA, LTE).

At 308, the access terminal 102 obtains the threshold values for the minimum signal parameters, such as a signal-to-noise ratio and a signal strength, that must be met before the access terminal 102 will connect to the target cell. In at least one example, the access terminal 102 obtains these threshold values from the channel release message. In other words, the network node 302 can include these threshold values in the channel release message. In one or more other examples, these threshold values are pre-provisioned in the access terminal 102, and the access terminal 102 can obtain the values from a storage medium in the access terminal 102. The pre-provisioned threshold values may be provided by the operator at the time of registration or any other time prior to receiving the channel release message.

After the access terminal 102 obtains the threshold values, it analyzes the target cell to determine whether the signal parameters (e.g., signal-to-noise ratio and the signal strength) are above the thresholds, at 310. In some examples, the access terminal 102 measures these signal parameters while monitoring for pages (i.e., camping) on the serving cell (e.g., the serving radio access technology, such as GSM). In other examples, the access terminal 102 moves to the target cell (e.g., target radio access technology, such as WCDMA, LTE) for a certain period of time and tries to find a new wireless network device (e.g., base station) where the signal parameters are above the threshold.

At 312, if the signal parameters (or metrics) are above the threshold values, then the access terminal 102 connects to the target cell. Otherwise, if at 314 the signal parameters are below the threshold, then the access terminal 102 stays camped on the GSM cell.

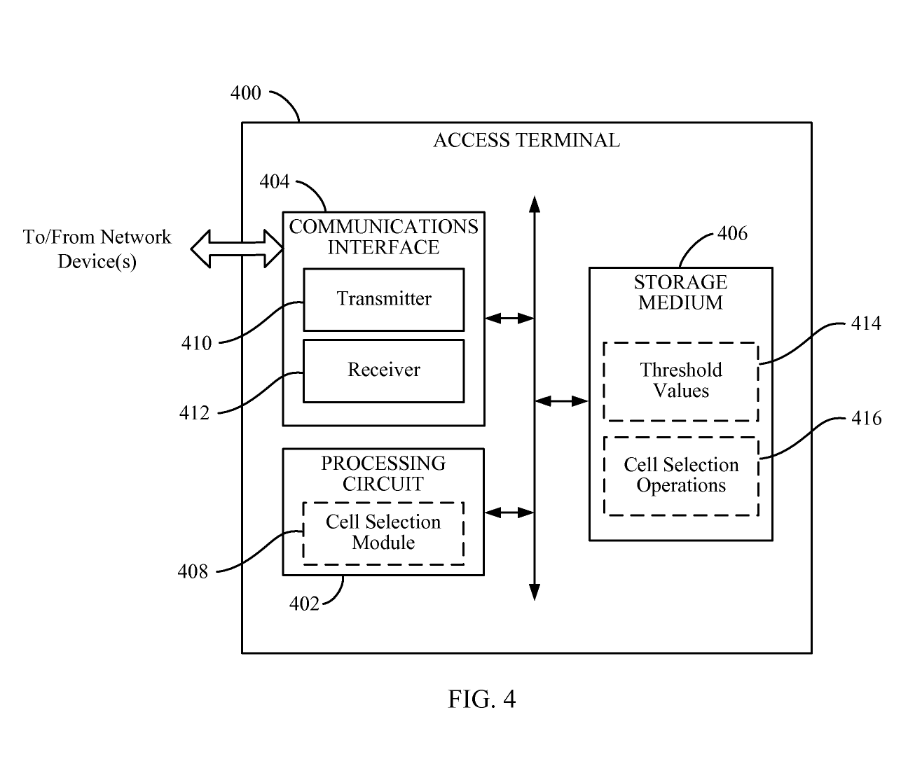

FIG. 4 is a block diagram illustrating select components of an access terminal 400 according to at least one example. The access terminal 400 may include a processing circuit 402 coupled to a communications interface 404 and to a storage medium 406.

The processing circuit 402 is arranged to obtain, process and/or send data, control data access and storage, issue commands, and control other desired operations. The processing circuit 402 may include circuitry configured to implement desired programming provided by appropriate media in at least one embodiment. For example, the processing circuit 402 may be implemented as one or more processors, one or more controllers, and/or other structure configured to execute executable programming Examples of the processing circuit 402 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 402 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 402 are for illustration and other suitable configurations within the scope of the present disclosure are also contemplated.

The processing circuit 402 is adapted for processing, including the execution of programming, which may be stored on the storage medium 406. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. According to at least one example, the processing circuit may include a cell selection module 408. The cell selection module 408 may include circuitry and/or programming (e.g., programming stored on the storage medium 406) adapted to perform the cell selection operations described herein with respect to an access terminal.

The communications interface 404 is configured to facilitate wireless communications of the access terminal 400. For example, the communications interface 404 may include circuitry and/or programming adapted to facilitate the communication of information bi-directionally with respect to one or more wireless network devices (e.g., network nodes). The communications interface 404 may be coupled to one or more antennas (not shown), and includes wireless transceiver circuitry, including at least one receiver circuit 410 (e.g., one or more receiver chains) and/or at least one transmitter circuit 412 (e.g., one or more transmitter chains).

The storage medium 406 may represent one or more devices for storing programming and/or data, such as processor executable code or instructions (e.g., software, firmware), electronic data, databases, or other digital information. The storage medium 406 may also be used for storing data that is manipulated by the processing circuit 402 when executing programming The storage medium 406 may be any available media that can be accessed by a general purpose or special purpose processor. By way of example and not limitation, the storage medium 406 may include a non-transitory computer-readable medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other non-transitory computer-readable mediums for storing information, as well as any combination thereof.

The storage medium 406 may be coupled to the processing circuit 402 such that the processing circuit 402 can read information from, and write information to, the storage medium 406. That is, the storage medium 406 can be coupled to the processing circuit 402 so that the storage medium 406 is at least accessible by the processing circuit 402, including examples where the storage medium 406 is integral to the processing circuit 402 and/or examples where the storage medium 406 is separate from the processing circuit 402 (e.g., resident in the access terminal 400, external to the access terminal 400, distributed across multiple entities).

Programming stored by the storage medium 406, when executed by the processing circuit 402, causes the processing circuit 402 to perform one or more of the various functions and/or process steps described herein. The storage medium 406 may include threshold values 414 and/or cell selection operations (i.e., instructions) 416. The threshold values 414 can include threshold values employable by the processing circuit 402 in, for example, the cell selection module 408 for determining whether signal parameters (or metrics) of a target cell are sufficient for selecting the target cell as described herein. By way of example, the threshold values 414 may include values for signal-to-noise (e.g., EcNo) and/or signal strength (e.g., received signal code power (RSCP)). The cell selection operations 416 may include programming that can be implemented by the processing circuit 402 in, for example, the cell selection module 408. Thus, according to one or more aspects of the present disclosure, the processing circuit 402 may be adapted to perform any or all of the processes, functions, steps and/or routines for any or all of the access terminals (e.g., access terminal 102) described herein. As used herein, the term “adapted” in relation to the processing circuit 402 may refer to the processing circuit 402 being one or more of configured, employed, implemented, and/or programmed to perform a particular process, function, step and/or routine according to various features described herein.

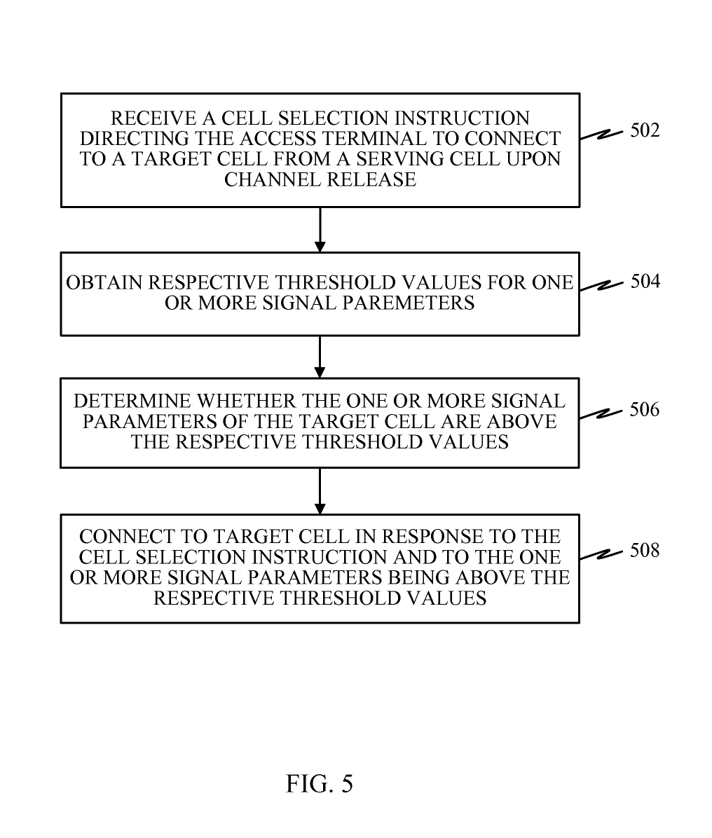

FIG. 5 is a flow diagram illustrating at least one example of a method operational on an access terminal, such as the access terminal 400. With reference to FIGS. 4 and 5, an access terminal 400 receives a cell selection instruction directing the access terminal 400 to connect to a target cell from a serving cell upon channel release, at step 502. For example, the processing circuit 402 (e.g., the cell selection module 408) executing the cell selection operations 416 may receive the cell selection instruction via the communications interface 404. In some examples, the cell selection instruction may be included with a channel release message received via the communications circuit 404 at the end of an active call with a wireless network device. The cell selection instruction may be a cell selection indicator after release of all traffic channels (TCH) and standalone dedicated control channels (SDCCH). As noted above, this cell selection instruction directs the processing circuit (e.g., the cell selection module 408) executing the cell selection operations 416 to change from the serving cell and connect to a target cell on release of the one or more channels. The cell selection instruction may specify the target cell by a particular base station identifier or by a particular radio access technology (e.g., to WCDMA, LTE).

At step 504, the access terminal 400 can obtain respective threshold values for one or more signal parameters. For instance, the processing circuit 402 (e.g., the cell selection module 408) executing the cell selection operations 416 may obtain respective threshold values for the one or more signal parameters, which signal parameters may include a signal-to-noise ratio and/or a signal strength. In at least one example, the respective threshold values may be pre-provisioned and stored in the storage medium 406, such that the processing circuit 402 (e.g., the cell selection module 408) executing the cell selection operations 416 may obtain the respective threshold values 414 from the storage medium 406. In one or more other examples, the processing circuit 402 (e.g., the cell selection module 408) executing the cell selection operations 416 may receive via the communications interface 404 the respective threshold values from the network together with the cell selection instruction. For instance, the processing circuit 402 may receive a channel release message via the communications interface 404 including both the respective threshold values and the cell selection instruction.

At step 506, the access terminal 500 determines whether the one or more signal parameters of the target cell are above the respective threshold values. For example, the processing circuit 402 (e.g., the cell selection module 408) executing the cell selection operations 416 can determine whether the one or more signal parameters of the target cell are above the respective threshold values. In at least one example, the processing circuit 402 (e.g., the cell selection module 408) executing the cell selection operations 416 can measure the one or more signal parameters of the target cell. In some instances, the processing circuit 402 may measure the one or more signal parameters for the target cell before moving from the serving cell. In other words, the processing circuit 402 may measure the one or more signal parameters for the target cell while monitoring for pages (i.e., camping) on the serving cell. In other instances, the processing circuit 402 may switch (or move) to a radio access technology (RAT) associated with the target cell for a predetermined period of time, and may measure the one or more signal parameters for one or more cells in the target RAT in search of a cell in the target RAT where the one or more signal parameters are above the respective threshold values.

After measuring the one or more signal parameters, the processing circuit 402 (e.g., the cell selection module 408) executing the cell selection operations 416 can compare the measured values with the respective threshold values. That is, the processing circuit 402 can analyze the measured value for each of the one or more signal parameters to establish whether each measure value is above a respective threshold value.

If the one or more signal parameters are determined to be above the respective threshold values at step 506, the access terminal 500 can connect to the target cell at step 508. For example, the processing circuit 402 (e.g., the cell selection module 408) executing the cell selection operations 416 can connect to the target cell in response to the cell selection instruction directing the access terminal 400 to changes to the target cell, and in response to the one or more signal parameters being above the respective threshold values. Connection to the target cell may include a conventional connection procedure according to the radio access technology and any associated standards.

If, on the other hand, at least one signal parameters is determined not to be above the respective threshold value, the access terminal 500 can employ the serving cell. For example, if the processing circuit 402 remained connected to the serving cell while measuring the one or more signal parameters for the target cell, then the processing circuit 402 may remain camped on the serving cell. If the processing circuit 402 switched to a radio access technology associated with the target cell, then the processing circuit 402 can return back to the radio access technology associated with the serving cell and can connect again to, and camp on the serving cell.

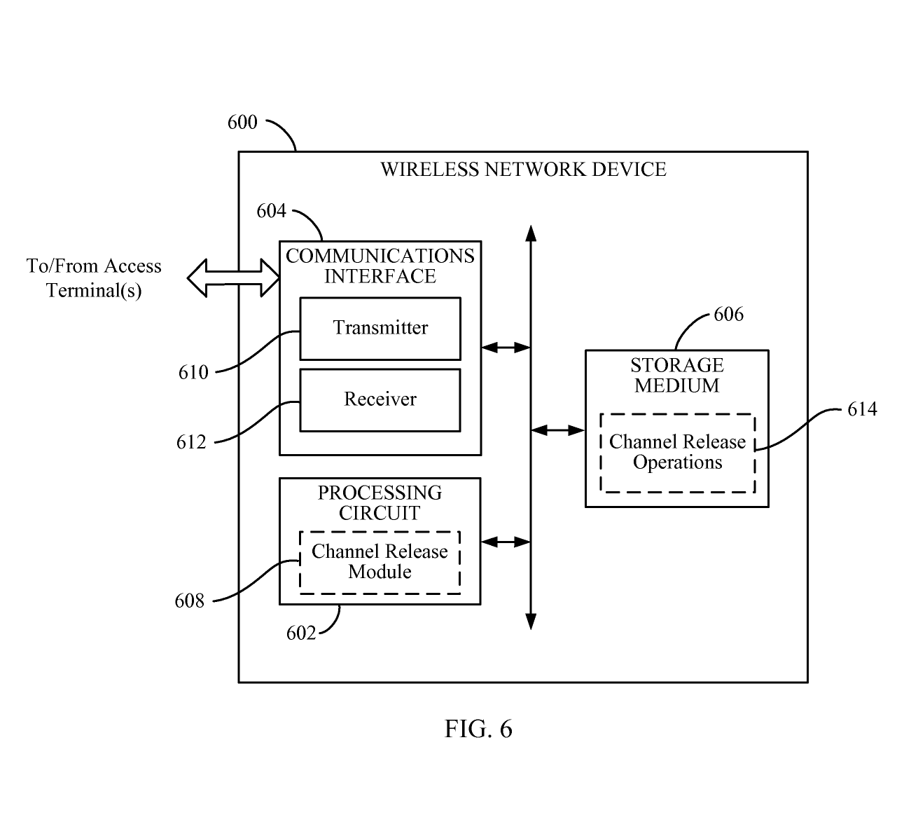

FIG. 6 is a block diagram illustrating select components of a wireless network device 600 according to at least one example. The wireless network device 600 may include a processing circuit 602 coupled to a communications interface 604 and to a storage medium 606.

The processing circuit 602 is generally configured as described above with reference to the processing circuit 402 in FIG. 4, except that instead of a cell selection module, the processing circuit 602 can include a channel release module 608. The channel release module 608 may include circuitry and/or programming (e.g., programming stored on the storage medium 606) adapted to perform the channel release operations described herein with respect to a wireless network device.

The communications interface 604 is configured to facilitate wireless communications of the wireless network device 600. For example, the communications interface 604 may include circuitry and/or programming adapted to facilitate the communication of information bi-directionally with respect to one or more access terminals. The communications interface 604 may be coupled to one or more antennas (not shown), and includes wireless transceiver circuitry, including at least one receiver circuit 610 (e.g., one or more receiver chains) and/or at least one transmitter circuit 612 (e.g., one or more transmitter chains).

The storage medium 606 may be generally configured similar to the storage medium 406 described above with reference to FIG. 4, except that the storage medium 606 may include different programming and/or data from the programming and/or data stored in the storage medium 406 in FIG. 4. For instance, the storage medium 606 may include channel release operations (i.e., instructions) 614. The channel release operations 614 includes programming that can be implemented by the processing circuit 602 in, for example, the channel release module 608. Thus, according to one or more aspects of the present disclosure, the processing circuit 602 may be adapted to perform any or all of the processes, functions, steps and/or routines for any or all of the wireless network devices (e.g., radio access network 104, base station 108, base station controller 110, base station A1, base station B1, network node 302, etc.) described herein. As used herein, the term “adapted” in relation to the processing circuit 602 may refer to the processing circuit 602 being one or more of configured, employed, implemented, and/or programmed to perform a particular process, function, step and/or routine according to various features described herein.

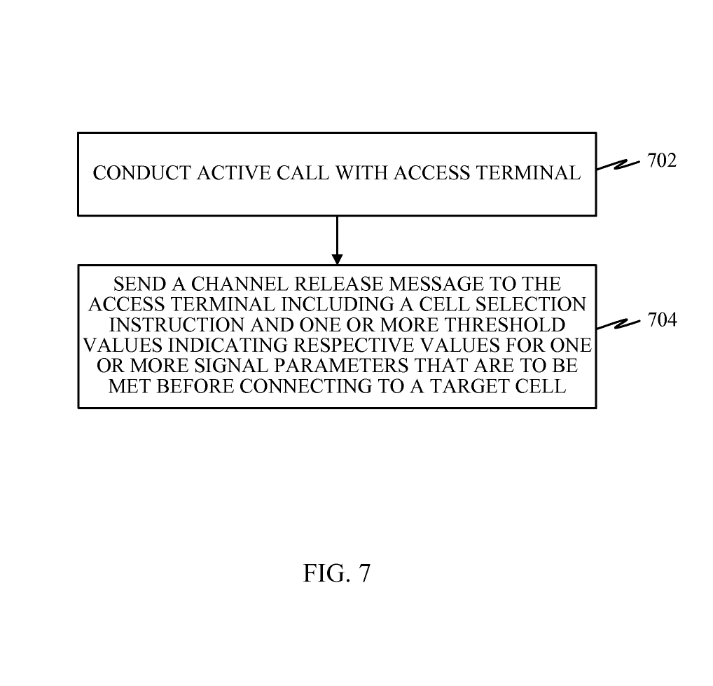

FIG. 7 is a flow diagram illustrating at least one example of a method operational on a wireless network device, such as the wireless network device 600. With reference to FIGS. 6 and 7, a wireless network device 600 can conduct an active call with an access terminal at step 702. For example, the processing circuit 602 can actively communicate with an access terminal via the communications interface 604. In at least one example, the active call may be a circuit-switched GSM call, in which the communications between the wireless network device 600 and the access terminal can be conducted according to the standards associated with the GSM radio access technology.

At the end of the active call, the wireless network device 600 can send a channel release message to the access terminal at step 704. For example, the processing circuit 602 (e.g., the channel release module 608) executing the channel release operations 614 may generate and send via the communications interface 604 a channel release message. The channel release message generated by the processing circuit 602 and sent via the communications interface can include a cell selection instruction and one or more threshold values.

The cell selection instruction is adapted to direct the access terminal to connect to a target cell upon channel release. In at least one example, where the active call is a circuit-switched GSM call, the cell selection instruction can be a cell selection indicator after release of all traffic channels (TCH) and standalone dedicated control channels (SDCCH). In some instances, the cell selection instruction may identify a particular cell (or wireless network device) on which the access terminal is instructed to camp as quickly as possible. In other instances, the cell selection instruction may identify a radio access technology (RAT) on which the access terminal is instructed to camp as quickly as possible. The radio access technology can be identified by a frequency associated with the radio access technology.

The one or more threshold values can indicate respective values for one or more signal parameters that are to be met before the access terminal is to connect to the target cell. For example, the one or more threshold values may indicate respective values for signal-to-noise ratio and for signal strength that are to be met or exceeded before the access terminal is to connect to the target cell.

One or more of the components, steps, features and/or functions illustrated in FIGS. 1, 2, 3, 4, 5, 6, and/or 7 may be rearranged and/or combined into a single component, step, feature or function or embodied in several components, steps, or functions. Additional elements, components, steps, and/or functions may also be added without departing from the scope of the present disclosure. The apparatus, devices, and/or components illustrated in FIGS. 1, 2, 4 and/or 6 may be configured to perform one or more of the methods, features, or steps described in FIGS. 3, 5 and/or 7. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The terms “machine-readable medium”, “computer-readable medium”, and/or “processor-readable medium” may include, but are not limited to portable or fixed storage devices, optical storage devices, and various other non-transitory mediums capable of storing, containing or carrying instruction(s) and/or data. Thus, the various methods described herein may be partially or fully implemented by instructions and/or data that may be stored in a “machine-readable medium”, “computer-readable medium”, and/or “processor-readable medium” and executed by one or more processors, machines and/or devices.

The various features associate with the examples described herein and shown in the accompanying drawings can be implemented in different examples and implementations without departing from the scope of the present disclosure. Therefore, although certain specific constructions and arrangements have been described and shown in the accompanying drawings, such configurations are merely illustrative and not restrictive of the scope of the disclosure, since various other additions and modifications to, and deletions from, the described configurations will be apparent to one of ordinary skill in the art. Thus, the scope of the disclosure is only determined by the literal language, and legal equivalents, of the allowed claims.

We claim:

1. An access terminal, comprising:
a communications interface adapted to facilitate wireless communications;
a storage medium; and
a processing circuit coupled with the communications interface and the storage medium, the processing circuit adapted to:
receive via the communications interface a cell selection instruction directing the access terminal to connect to a target cell from a serving cell upon a channel release;
determine whether one or more signal parameters of the target cell are above respective threshold values; and
connect to the target cell in response to the cell selection instruction and to the one or more signal parameters being above the respective threshold values.

2. The access terminal of claim 1, wherein the cell selection instruction is included in a channel release message received via the communications interface at the end of an active call.

3. The access terminal of claim 2, wherein the processing circuit is further adapted to obtain the respective threshold values for the one or more signal parameters from the received channel release message.

4. The access terminal of claim 1, wherein the one or more signal parameters include a signal-to-noise ratio and a signal strength.

5. The access terminal of claim 1, wherein the processing circuit adapted to determine whether the one or more signal parameters of the target cell are above the respective threshold values comprises the processing circuit adapted to:
measure the one or more signal parameters for the target cell while monitoring for pages on the serving cell.

6. The access terminal of claim 1, wherein the processing circuit adapted to determine whether the one or more signal parameters of the target cell are above the respective threshold values comprises the processing circuit adapted to:
move to a target radio access technology for a predetermined period of time; and
search for a cell in the target radio access technology where the one or more signal parameters are above the respective thresholds.

7. The access terminal of claim 1, wherein the processing circuit is further adapted to obtain the respective threshold values for the one or more signal parameters from the storage medium as pre-provisioned values stored in the storage medium.

8. A method operational on an access terminal, comprising:
receiving a cell selection instruction directing the access terminal to connect to a target cell from a serving cell upon a channel release;
determining whether one or more signal parameters of the target cell are above respective threshold values; and
connecting to the target cell in response to the cell selection instruction and to the one or more signal parameters being above the respective threshold values.

9. The method of claim 8, wherein receiving the cell selection instruction comprises:
receiving a channel release message at the end of an active call, wherein the channel release message includes the cell selection instruction.

10. The method of claim 8, wherein determining whether the one or more signal parameters of the target cell are above the respective threshold values comprises:
measuring the one or more signal parameters for the target cell before moving from the serving cell.

11. The method of claim 8, wherein determining whether the one or more signal parameters of the target cell are above the respective threshold values comprises:
moving to a radio access technology associated with the target cell for a predetermined period of time; and
measuring the one or more signal parameters after moving to the radio access technology associated with the target cell.

12. The method of claim 8, further comprising:
obtaining the respective threshold values for the one or more signal parameters prior to determining whether the one or more signal parameters of the target cell are above the respective threshold values.

13. The method of claim 12, wherein obtaining the respective threshold values for the one or more signal parameters comprises:
obtaining respective threshold values for signal parameters including signal-to-noise ratio and signal strength.

14. The method of claim 12, wherein obtaining the respective threshold values for the one or more signal parameters comprises:
receiving the respective threshold values together with the cell selection instruction.

15. The method of claim 12, wherein obtaining the respective threshold values for the one or more signal parameters comprises:
obtaining from a storage medium pre-provisioned threshold values associated with each of the one or more signal parameters.

16. An access terminal, comprising:
means for receiving a cell selection instruction directing the access terminal to connect to a target cell from a serving cell upon a channel release;
means for determining whether one or more signal parameters of the target cell are above respective threshold values; and
means for connecting to the target cell in response to the cell selection instruction and to the one or more signal parameters being above the respective threshold values.

17. The access terminal of claim 16, further comprising:
means for obtaining the respective threshold values for the one or more signal parameters.

18. The access terminal of claim 16, wherein the cell selection instruction is included with a channel release message received at the end of an active call.

19. The access terminal of claim 16, wherein the one or more signal parameters include a signal-to-noise ratio and a signal strength.

20. A processor-readable medium comprising programming operational on an access terminal for:
receiving a cell selection instruction directing the access terminal to connect to a target cell from a serving cell upon a channel release;
determining whether one or more signal parameters of the target cell are above respective threshold values; and
connecting to the target cell in response to the cell selection instruction and to the one or more signal parameters being above the respective threshold values.

21. The processor-readable medium of claim 20, further comprising programming operational on the access terminal for:
receiving the respective threshold values for the one or more signal parameters together with the cell selection instruction.

22. The processor-readable medium of claim 20, wherein determining whether the one or more signal parameters of the target cell are above the respective threshold values comprises:
measuring the one or more signal parameters for the target cell while monitoring for pages on the serving cell.

23. The processor-readable medium of claim 20, wherein determining whether the one or more signal parameters of the target cell are above the respective threshold values comprises:
moving to a radio access technology associated with the target cell for a predetermined period of time; and
measuring the one or more signal parameters after moving to the radio access technology associated with the target cell.

24. A wireless network device, comprising:
a communications interface;
a storage medium; and
a processing circuit coupled to the communications interface and the storage medium, the processing circuit adapted to send a channel release message to an access terminal via the communications interface, wherein the channel release message includes:
a cell selection instruction directing the access terminal to connect to a target cell upon channel release; and
one or more threshold values indicating respective values for one or more signal parameters that are to be met before connecting to the target cell.

25. The wireless network device of claim 24, wherein the one or more signal parameters include a signal-to-noise ratio and a signal strength.

26. The wireless network device of claim 24, wherein the cell selection instruction is adapted to identify a cell on which the access terminal is to camp as quickly as possible.

27. The wireless network device of claim 24, wherein the cell selection instruction is adapted to identify a frequency associated with a radio access technology on which the access terminal is to camp as soon as possible.

28. A method operational on a wireless network device, comprising:
conducting an active call with an access terminal; and
sending a channel release message to the access terminal, where the channel release message includes:
a cell selection instruction directing the access terminal to connect to a target cell upon channel release; and
one or more threshold values indicating respective values for one or more signal parameters that are to be met before connecting to the target cell.

29. The method of claim 28, wherein the cell selection instruction is adapted to identify a cell on which the access terminal is to camp as quickly as possible.

30. The method of claim 28, wherein the cell selection instruction is adapted to identify a frequency associated with a radio access technology on which the access terminal is to camp as soon as possible.

31. A wireless network device, comprising:
means for conducting an active call with an access terminal; and
means for sending a channel release message to the access terminal, where the channel release message includes:
a cell selection instruction directing the access terminal to connect to a target cell upon channel release; and
one or more threshold values indicating respective values for one or more signal parameters that are to be met before connecting to the target cell.

32. A processor-readable medium comprising programming operational on a wireless network device for:
conducting an active call with an access terminal; and
sending a channel release message to the access terminal, where the channel release message includes:
a cell selection instruction directing the access terminal to connect to a target cell upon channel release; and
one or more threshold values indicating respective values for one or more signal parameters that are to be met before connecting to the target cell.
